(19) United States
(12) Patent Application Publication
(10) Pub. No.: US 2019/0124274 A1
(43) Pub. Date: Apr. 25, 2019

(54) IMAGE PROCESSING APPARATUS, IMAGING SYSTEM, COMMUNICATION SYSTEM, IMAGE PROCESSING METHOD, AND RECORDING MEDIUM

(71) Applicants: Takuroh NAITOH, Tokyo (JP); Takahiro ASAI, Kanagawa (JP); Keiichi KAWAGUCHI, Kanagawa (JP); Eichi KOIZUMI, Kanagawa (JP)

(72) Inventors: Takuroh NAITOH, Tokyo (JP); Takahiro ASAI, Kanagawa (JP); Keiichi KAWAGUCHI, Kanagawa (JP); Eichi KOIZUMI, Kanagawa (JP)

(21) Appl. No.: 16/166,199

(22) Filed: Oct. 22, 2018

(30) Foreign Application Priority Data
Oct. 25, 2017 (JP) 2017-205739

(51) Int. Cl. H04N 5/262; H04N 5/232; H04N 5/225

(52) U.S. Cl. CPC H04N 5/2628; H04N 5/2258; H04N 5/23238; H04N 5/23296

(57) ABSTRACT

An image processing apparatus for processing a plurality of images captured by an image capturing device, the image capturing device including a plurality of imaging elements each of which captures an imaging area with a preset angle of view, imaging areas of at least two of the plurality of imaging elements overlapping with each other, includes circuitry to: obtain the plurality of images captured by the image capturing device; convert at least one image of the plurality of images, to an image having an angle of view that is smaller than the preset angle of view; and combine the plurality of images including the at least one image that is converted, into a combined image.

### CROSS-REFERENCE TO RELATED APPLICATIONS

This patent application is based on and claims priority pursuant to 35 U.S.C. § 119(a) to Japanese Patent Application No. 2017-205739, filed on Oct. 25, 2017, in the Japan Patent Office, the entire disclosure of which is hereby incorporated by reference herein.

### BACKGROUND

### Technical Field

The present invention relates to an image processing apparatus, an imaging system, a communication system, an image processing method, and a recording medium.

### Description of the Related Art

For example, when an accident related to a vehicle (such as a car, an aircraft, etc.) occurs, an image taken by a drive recorder is collected and used to investigate a possible cause of the accident or to take countermeasures. In the case of a large-size vehicle, sensors can be installed in various parts of the vehicle to obtain visual information around a body of the vehicle. However, in the case of a small-size vehicle, a place to attach the sensor is also limited. It is thus desirable to have a compact imaging system capable of obtaining an image of surroundings of the vehicle.

### SUMMARY

Example embodiments of the present invention include an image processing apparatus for processing a plurality of images captured by an image capturing device, the image capturing device including a plurality of imaging elements each of which captures an imaging area with a preset angle of view, imaging areas of at least two of the plurality of imaging elements overlapping with each other. The image processing apparatus includes: circuitry to: obtain the plurality of images captured by the image capturing device; convert at least one image of the plurality of images, to an image having an angle of view that is smaller than the preset angle of view; and combine the plurality of images including the at least one image that is converted, into a combined image.

Example embodiments of the present invention include an imaging system including the image processing apparatus and the image capturing device.

Example embodiments of the present invention include a communication system including the image processing apparatus and a communication terminal.

Example embodiments of the present invention include an image processing method performed by the image processing apparatus, and a recording medium storing a control program for performing the image processing method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of a communication system according to an embodiment;

FIG. 2 is a schematic diagram illustrating a configuration of an imaging system according to an embodiment;

FIG. 3 is a diagram illustrating an example of an imaging range of the imaging system of FIG. 2, according to the embodiment;

FIGS. 4A and 4B each illustrate an example of an imaging range of the imaging system when mounted on a small-size construction machine;

FIG. 5 is a schematic diagram illustrating a hardware configuration of an image processing board in the imaging system of FIG. 2, according to an embodiment;

FIG. 6 is a schematic diagram illustrating a hardware configuration of a controller of a camera in the imaging system of FIG. 2, according to an embodiment;

FIG. 7 is a schematic block diagram illustrating a functional configuration of the imaging system of FIG. 2, according to an embodiment;

FIGS. 8A and 8B are diagrams for explaining a shooting (imaging) direction of the camera, according to an embodiment;

FIGS. 9A and 9B are diagrams for explaining a projection relation in the camera having a fisheye lens, according an embodiment;

FIG. 9C is a table illustrating a relation between an incident angle and an image height, as projection transformation data, according to an embodiment;

FIGS. 10A and 10B are diagrams for explaining an example processing of texture mapping a fisheye image captured by the camera on a three-dimensional sphere;

FIGS. 11A to 11C are diagrams illustrating an example of applying perspective projection transformation to the fisheye image;

FIGS. 12A and 12B are diagrams for explaining operation of converting fisheye images captured by the camera with two fisheye lenses, to hemispherical images, according to an embodiment;

FIGS. 13A and 13B are diagrams for explaining a method of converting an image captured by the imaging system, to an image of 180°;

FIGS. 14A and 14B are diagrams for explaining an example of converting an image captured by the imaging system, to an image of 180° by expansion and compression;

FIG. 15 is a flowchart illustrating operation of obtaining image data and projection transformation information for transmission, performed by the camera, according to an embodiment;

FIG. 16 is a flowchart illustrating operation of generating a spherical image based on the image data and the projection transformation information received from the camera, according to an embodiment;

FIG. 17 is an illustration of an example predetermined area of a spherical image, displayed on a display;

FIGS. 18A and 18B are schematic diagrams each illustrating a configuration of an imaging system according to a modified example;

FIG. 19 is a diagram for explaining a method of extending and compressing an image, according to an embodiment;

FIGS. 20A and 20B are conceptual diagrams illustrating generating a spherical image, performed by the imaging system of FIGS. 18A and 18B, according to the modified example;

FIG. 21 is a schematic block diagram illustrating a functional configuration of the communication system, according to another modified example; and

FIG. 22 is a sequence diagram illustrating operation of generating and reproducing a spherical image, performed by the communication system of FIG. 21, according to the modified example.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, embodiments of the present invention are described.

<<<Overall Configuration>>>

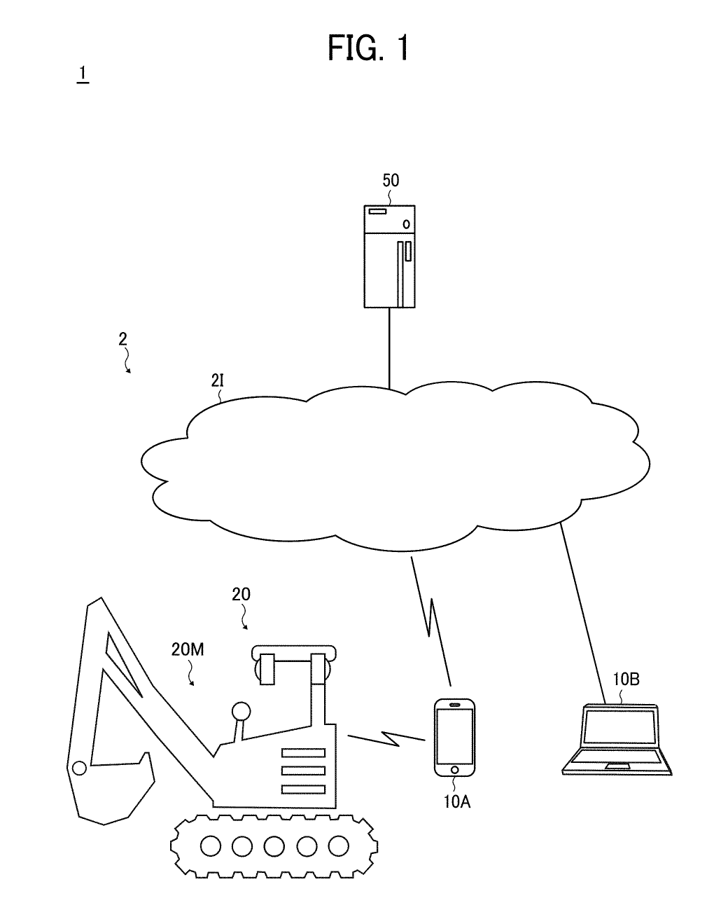

FIG. 1 is a schematic diagram illustrating an overall configuration of a communication system according to an embodiment of the present invention. Hereinafter, a communication terminal is simply referred to as a terminal. As illustrated in FIG. 1, the communication system 1 includes a plurality of terminals 10A and 10B, an imaging system 20, and a management system 50. For simplicity, an arbitrary one of the terminals 10A and 10B is referred to as the terminal 10.

The terminal 10 is an information processing apparatus having a communication function and is, for example, a smart device such as a tablet, a smartphone, or a single board computer, or an information processing apparatus such as a personal computer (PC). Hereinafter, the case where the terminal 10A is a smart device and the terminal 10B is a PC will be described.

The imaging system 20, which is mounted on a mobile body 20M, is an information processing system having an image capturing function, an image processing function, and a communication function. The mobile body 20M is exemplified by, but not limited to, an automobile such as a construction machine, a forklift, a truck, a passenger car, or a two-wheeled vehicle, or a flying object such as a drone, a helicopter, or a small-size airplane.

The management system 50 is an information processing apparatus having a communication function and an image processing function. The management system 50 functions as a Web server, which transmits images to the terminal 10 in response to a request from the terminal 10 for display at the terminal 10.

The terminal 10A and the imaging system 20 are connected by wireless communication in compliance with Wireless Fidelity (Wi-Fi) or Bluetooth (Registered Trademark), or by wired communication via a Universal Serial Bus (USB) cable or the like. The terminal 10A is connected to the Internet 2I via Wi-Fi, wireless local area network (LAN), or the like or via a base station. With this configuration, the terminal 10A establishes communication with the management system 50 on the Internet 2I. Further, the terminal 10B is connected to the Internet 2I via a LAN. With this configuration, the terminal 10B establishes communication with the management system 50. Hereinafter, the Internet 2I, the LAN, and various wired and wireless communication paths are collectively referred to as a communication network 2.

<<Imaging System>>

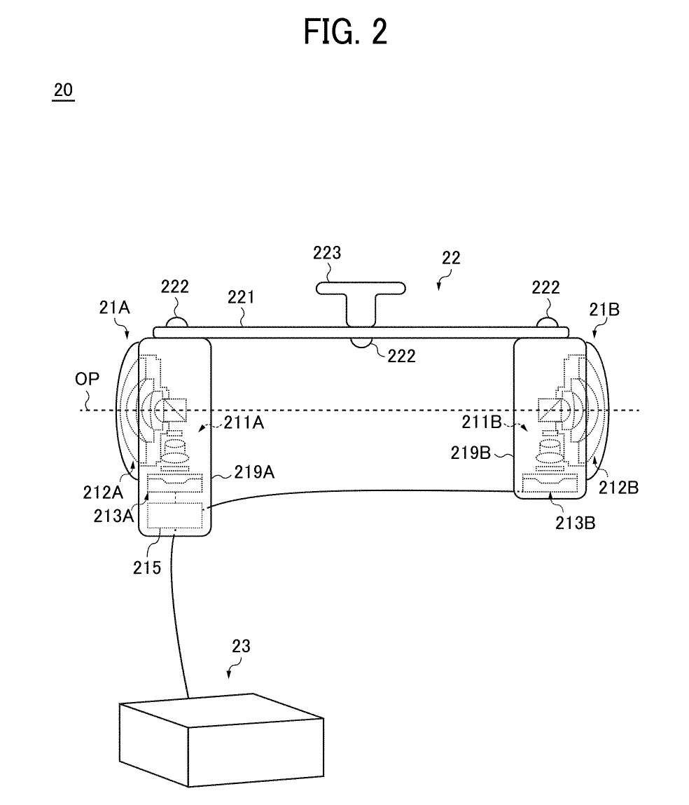

FIG. 2 is a schematic diagram illustrating a configuration of the imaging system 20 according to an embodiment. The imaging system 20 includes two cameras 21A and 21B, a holder 22, and an image processing board 23. Any arbitrary one of the cameras 21A and 21B is referred to as the camera 21. The camera 21 and the image processing board 23 are electrically connected by a cable. It should be noted that the camera 21 and the image processing board 23 may be connected by wireless communication.

The cameras 21A and 21B include various components such as imaging units 211A and 211B, and batteries, which are respectively accommodated in housings 219A and 219B. The camera 21A further includes a controller 215. Hereinafter, any arbitrary one of the imaging units 211A and 211B is referred to as the imaging unit 211. In FIG. 2, an example configuration in which the controller 215 is accommodated in the camera 21A is illustrated. In this case, the images respectively captured by the cameras 21A and 21B are input to the controller 215 of the camera 21A via a cable or the like for processing. Alternatively, the cameras 21A and 21B may each be provided with a controller, which processes images captured by corresponding one of the cameras 21A and 21B.

The imaging units 211A and 211B include, respectively, imaging optical systems 212A and 212B, and imaging elements 213A and 213B such as Charge Coupled Device (CCD) sensor and Complementary Metal Oxide Semiconductor (CMOS) sensor. Hereinafter, any arbitrary one of the imaging elements 213A and 213B is referred to as the imaging element 213. Each of the imaging optical systems 212A and 212B includes, for example, seven fisheye lenses, which are grouped into 6 lens sets. The fisheye lens has a full angle of view that is larger than 180° (=360°/n; optical system number n=2). Preferably, the fisheye lens has an angle of view of 185° or larger, and more preferably, 190° or larger. A set of the wide-angle imaging optical system 212A and the imaging element 213A, and a set of the wide-angle imaging optical system 212B and the imaging element 213B are each referred to as a wide-angle imaging optical system.

The cameras 21A and 21B are respectively secured to a holding plate 221 of the holder 22 by two of a plurality of screws 222. It is desirable that the holding plate 221 is sufficiently strong such that it is hardly deformed due to external forces. The holding plate 221 is attached to a hook 223 by one of the screws 222, other than the screws for securing the cameras 21A and 21B. The hook 223, which is an example of a mounting part, could be any shape as long as it can be attached to a desired location on the mobile body 20M.

The optical elements (the lenses, the prisms, the filters, and the aperture stops) of the two imaging optical systems 212A and 212B are disposed for the respective imaging elements 213A and 213B. The positions of the optical elements of the imaging optical systems 212A and 212B are determined by the holder 22, such that the optical center axis OP that passes through the imaging optical systems 212A and 212B is made orthogonal to centers of light receiving areas of the imaging elements 213A and 213B, respectively. Further, the light receiving areas of the imaging elements 213A and 213B form imaging planes of the corresponding fisheye lenses.

In this example, the imaging optical systems 212A and 212B are substantially the same in specification, and disposed so as to face in opposite directions so that their respective optical central axes OP coincide with each other. The imaging elements 213A and 213B each convert a distribution of the received light into image signals, and sequentially output image frames (frame data) to an image processing circuit on the controller 215. The controller 215 then transfers the images (the image frames) captured by the imaging elements 213A and 213B to the image processing board 23 at which the images are combined into an image having a solid angle of 47c steradian (hereinafter referred to as the “spherical image”). The spherical image is obtained by capturing images of all directions that can be seen from an image capturing point. The spherical video image is generated from a set of consecutive frames of spherical image. Hereinafter, a process of generating a spherical image and a spherical video image will be described. However, this process can be replaced with a process of generating a so-called panorama image and a panorama video image, obtained by capturing images of only the horizontal plane by 360 degrees.

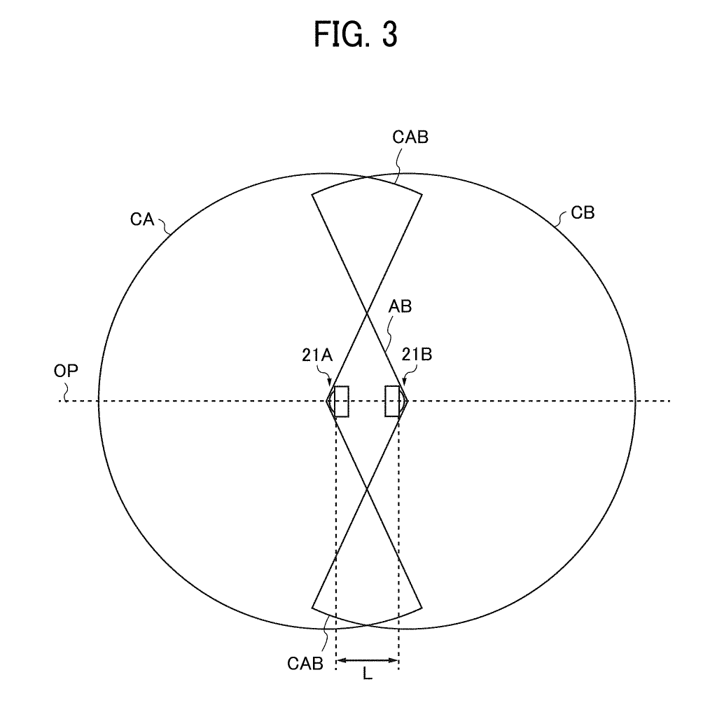

FIG. 3 is a diagram illustrating an example imaging range of the imaging system 20. In FIG. 3, the cameras 21A and 21B are arranged so as to face in opposite directions while keeping a distance L therebetween. An imaging range CA of the camera 21A and an imaging range CB of the camera 21B overlap each other in a range CAB. The optical central axes OP of the cameras 21A and 21B are in agreement. Accordingly, the image captured by the camera 21A and the image captured by the camera 21B are free from positional deviation in the overlapping range CAB. Further, when the images are captured, a blind spot AB which is not included in any one of the imaging range CA of the camera 21A and the imaging range CB of the camera 21B is generated.

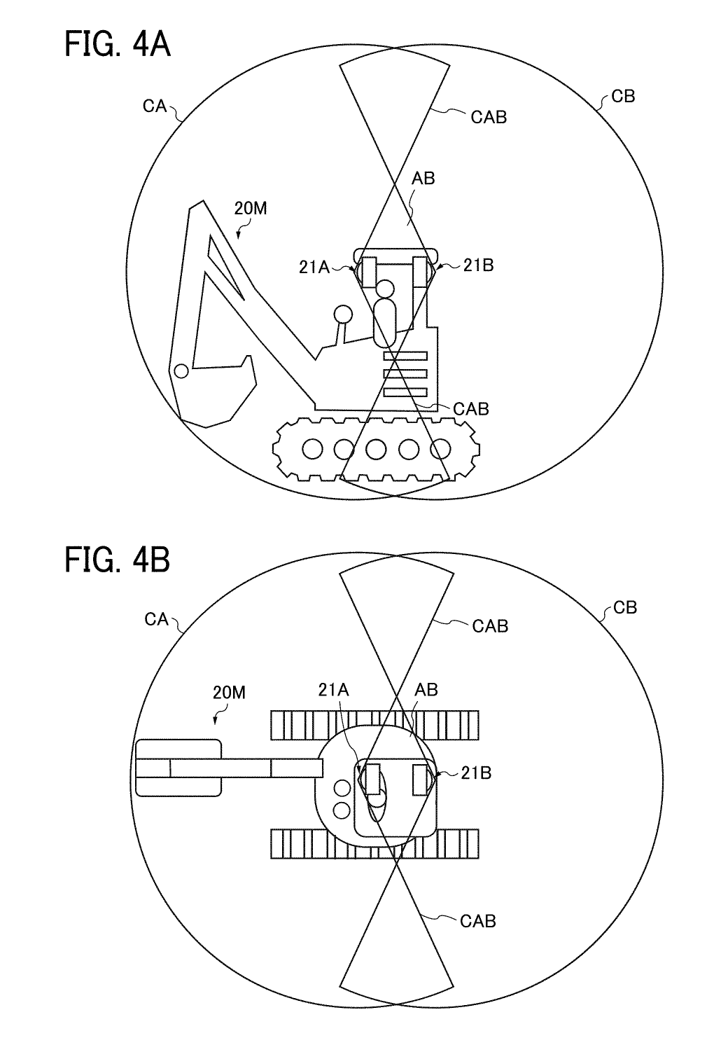

FIGS. 4A and 4B each illustrate an example of an imaging range of the imaging system 20 when mounted on a small-size construction machine. FIG. 4A is a side view of the small-size construction machine viewed from one side surface of the machine. FIG. 4B is a top view of the small-size construction machine viewed from a top side of the machine. At least two cameras 21A and 21B are installed in the small-size construction machine as the mobile body 20M, to capture all surroundings of the construction machine as well as hands and feet of an operator operating the construction machine. Unlike large-size construction machines, an installation space for the cameras is limited in small-size construction machines, thus, it is difficult to install a large-size imaging system for monitoring. As illustrated in FIGS. 4A and 4B, the imaging system 20 of the present embodiment is compact in size and lightweight, and have relatively a small number of components. Accordingly, the imaging system 20 is suitable especially to small-size construction machines. Even with such a configuration, the imaging system 20 is able to capture all surroundings of the construction machine. Although the blind spot AB exists, as illustrated in FIGS. 4A and 4B, such a blind spot AB is less important, as the operator is usually interested in capturing all surroundings of the construction machine. In this disclosure, the range of “all surroundings” is determined by the operator to be a range where monitoring is required, such as a working space of the construction machine. It is preferable that the range of all surroundings is an image capturing range that is needed to capture images from which a spherical image is generated as described above. However, especially when the cameras are installed in the small-size construction machine, a panorama image may be sufficient. The panorama image is an image, in which a part above or below the small-size construction machine is not shown.

<<Hardware Configuration>>

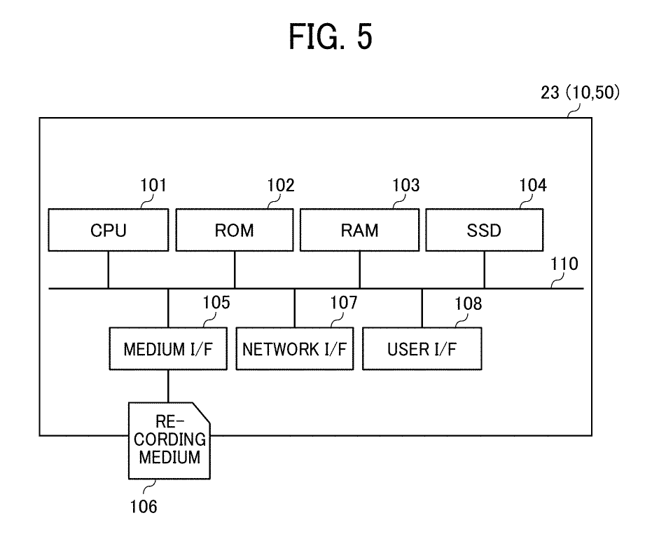

FIG. 5 is a schematic diagram illustrating a hardware configuration of the image processing board 23 according to an embodiment. The hardware configuration of the image processing board 23 will be described with reference to FIG. 5. The hardware configuration of the image processing board 23 is similar to the hardware configuration of a general information processing apparatus.

The image processing board 23 includes a Central Processing Unit (CPU) 101, a Read Only Memory 102 (ROM), a Random Access Memory (RAM) 103, a Solid State Drive (SSD) 104, a medium interface (I/F) 105, a network I/F 107, a user I/F 108, and a bus line 110.

The CPU 101 controls entire operation of the image processing board 23. The ROM 102 stores various programs that operate on the image processing board 23. The RAM 103 is used as a work area for the CPU 101. The SSD 104 stores data used by the CPU 101 in executing various programs. The SSD 104 can be replaced with any nonvolatile memory such as a Hard Disk Drive (HDD). The medium I/F 105 is an interface circuit for reading out information stored in a recording medium 106 such as an external memory, or writing information to the recording medium 106. The network I/F 107 is an interface circuit that enables the image processing board 23 to communicate with other devices via the communication network 2. The user I/F 108 is an interface circuit, which provides image information to a user or receives operation inputs from the user. The user IX 108 allows the image processing board 23 to connect with, for example, a liquid crystal display or an organic EL (ElectroLuminescence) display equipped with a touch panel, or a keyboard or a mouse. The bus line 110 is an address bus or a data bus for electrically connecting the respective elements illustrated in FIG. 5.

Since the hardware configuration of the terminal 10 and the management system 50 is the same as the hardware configuration of the image processing board 23 described above, its description is omitted.

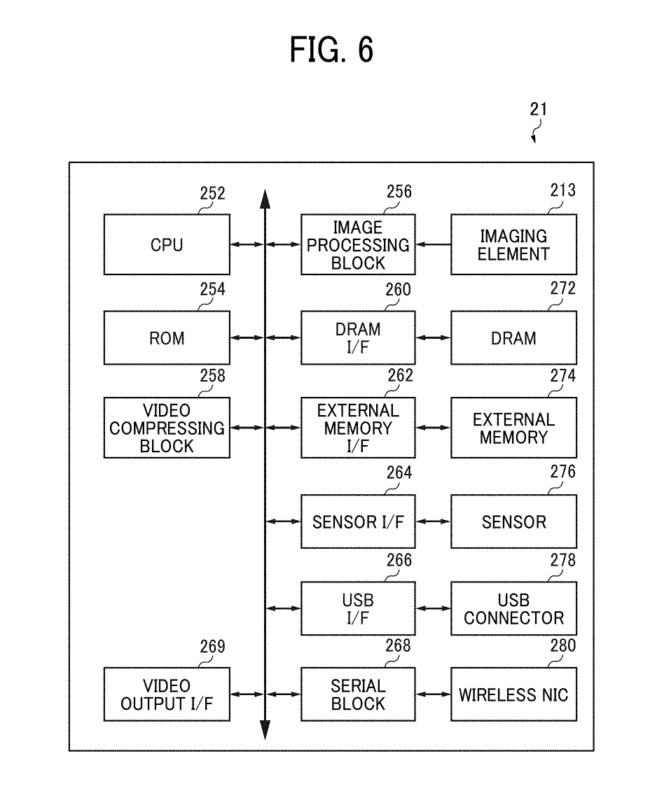

FIG. 6 is a schematic diagram illustrating a hardware configuration of the controller 215 and its peripheral of the camera 21 according to an embodiment. The controller 215 of the camera 21 includes a CPU 252, a ROM 254, an image processing block 256, a video compression block 258, a Dynamic Random Access Memory (DRAM) 272 connected via a DRAM I/F 260, and a sensor 276 connected via a sensor I/F 264.

The CPU 252 controls operation of respective elements in the camera 21. The ROM 254 stores control programs and various parameters described in codes that are interpretable by the CPU 252. The image processing block 256 is connected to the imaging elements 213A and 213B, and is input with image signals of the images being captured by the imaging elements 213A and 213B. The image processing block 256 includes an Image Signal Processor (ISP) and the like, and performs shading correction, Bayer interpolation, white balance correction, gamma correction, and the like on the image signals input from the imaging elements 213A and 213B.

The video compression block 258 is a codec block that compresses or decompresses a video according to such as MPEG-4 AVC/H.264. The DRAM 272 provides a storage area for temporarily storing data in applying various signal processing and image processing. The sensor 276 measures a physical quantity, such as a velocity, an acceleration, an angular velocity, an angular acceleration, or a magnetic direction, which results from a movement of the imaging element 213. For example, the sensor 276 may be an acceleration sensor, which detects acceleration components of three axes, which are used to detect the vertical direction to perform zenith correction on the spherical image.

The controller 215 of the camera 21 further includes an external memory I/F 262, a Universal Serial Bus (USB) I/F 266, a serial block 268, and a video output I/F 269. To the external memory I/F 262, an external memory 274 is connected. The external memory I/F 262 controls reading and writing to the external memory 274 such as a memory card inserted in a memory card slot. To the USB I/F 266, a USB connector 278 is connected. The USB I/F 266 controls USB communication with an external device such as a personal computer connected via the USB connector 278. The serial block 268 is connected with a wireless Network Interface Card (NIC) 280, and controls serial communication with an external device such as a personal computer. The video output I/F 269 is an interface for connecting the controller 215 with the image processing board 23.

While in this embodiment referring to FIG. 6, some elements are provided in the controller 215 or the camera 21, some elements may be provided externally to the camera 21, such as the external memory 274, the sensor 276, the USB connector 278, and the wireless NIC 280.

<<Functional Configuration>>

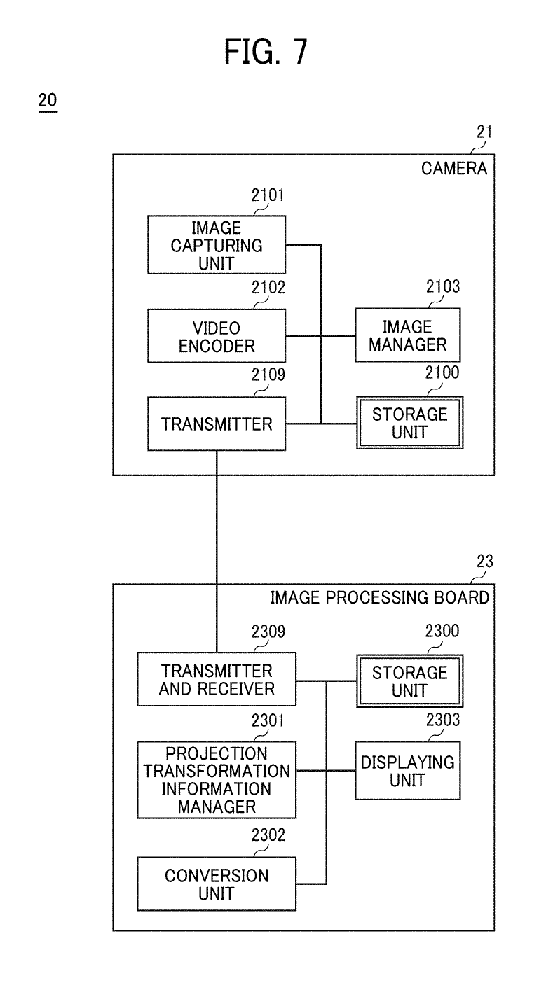

Next, a functional configuration of the imaging system 20 is described according to an embodiment. FIG. 7 is a schematic block diagram illustrating a functional configuration of the imaging system 20 according to the embodiment.

When the power of the camera 21 is turned on, the control program for the camera 21 is loaded, for example, from the ROM 254 to a main memory such as the DRAM 272. The CPU 252 controls operation of each part in the camera 21 according to the program loaded into the main memory, while temporarily saving data necessary for control on the memory. Accordingly, the camera 21 performs functions and operations as described below.

The camera 21 includes an image capturing unit 2101, a video encoder 2102, an image manager 2103, and a transmitter 2109. The camera 21 further includes a storage unit 2100 implemented by the ROM 254, DRAM 272, or external memory 274.

The image capturing unit 2101, which is implemented by the imaging element 213, captures a still image or a video. The video encoder 2102, which is implemented by the video compression block 258, encodes (compresses) or decodes (decompresses) the video. The image manager 2103, which is implemented by instructions of the CPU 252, stores in the memory the image data in association with projection transformation information for management. The transmitter 2109, which is implemented by instructions of the CPU 252 and the video output VF 269, controls communication with the image processing board 23.

The image processing board 23 includes a projection transformation information manager 2301, a conversion unit 2302, a displaying unit 2303, and a transmitter and receiver 2309. Further, the image processing board 23 includes a storage unit 2300, implemented by the ROM 102, the RAM 103, or the SSD 104.

The projection transformation information manager 2301, which is implemented by instructions of the CPU 101, manages projection transformation information of an image that is captured by the camera 21. The conversion unit 2302, which is implemented by instructions of the CPU 101, converts an angle of view of each image in a set of images, to generate a set of images each applied with projection transformation. The conversion unit 2302 then performs texture mapping with the set of images applied with projection transformation, onto a unit sphere, to generate a sphere image. The displaying unit 2303, which is implemented by instructions of the CPU 101 and a displaying function of the user I/F 108, displays the spherical image that is generated by combining the set of images. The transmitter and receiver 2309, which is implemented by instructions of the CPU 101 and the network T/F 107, controls communication with other devices.

<<Concept>>

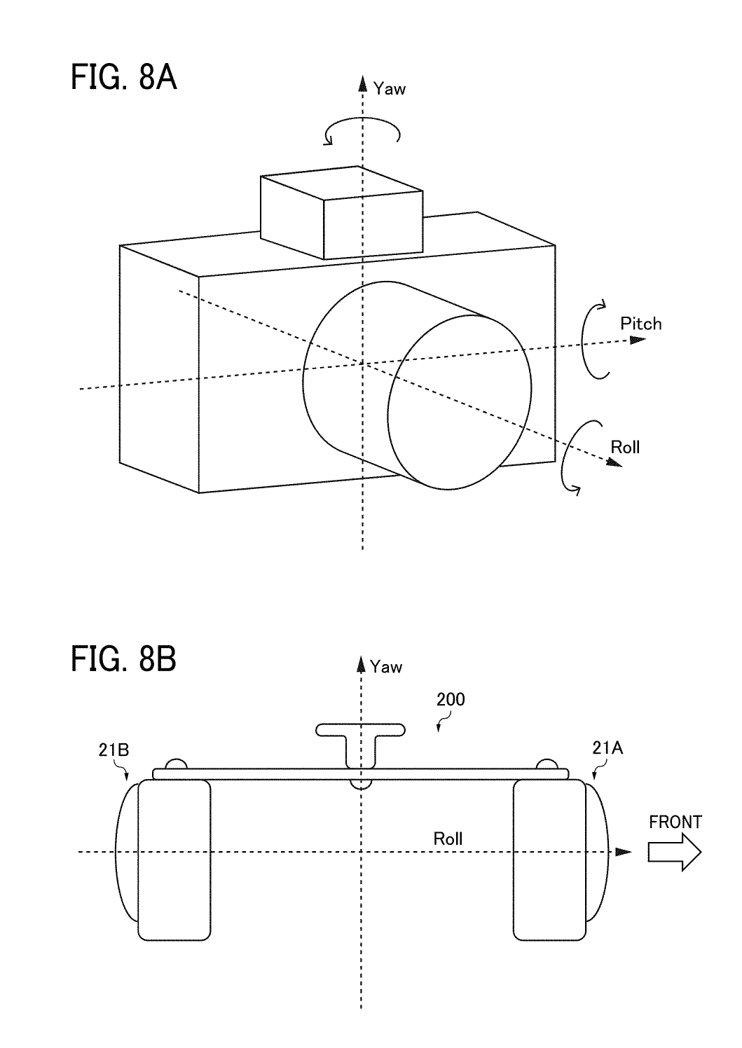

Next, a concept used for generating a spherical image from images captured by the camera 21 will be described. First, the direction in which the imaging system 20 captures images will be described. FIGS. 8A and 8B are diagrams for explaining the shooting (imaging) direction. FIG. 8A is a diagram for explaining how three axial directions with respect to the camera are defined. Here, the front direction of the camera, that is, the optical center axis direction of the lens is defined as a Roll axis, the vertical direction of the camera is defined as a Yaw axis, and a horizontal direction of the camera is defined as a Pitch axis.

The direction of the camera 21 can be represented by an angle of (Yaw, Pitch, Roll) with reference to a direction that the lens (imaging optical system 212A, 212B) of the camera 21A faces, which is defined as a reference direction. For example, in the camera 21 of FIG. 8B, since the camera 21A faces the front with respect to the reference direction, the camera 21A has an angle of (Yaw, Pitch, Roll)=(0, 0, 0). On the other hand, since the camera 21B faces in the opposite direction with respect to the reference direction, that is, the optical center axis direction (Roll axis direction), and is rotated by 180° with respect to the Yaw axis, the camera 21B has an angle of (Yaw, Pitch, Roll)=(180, 0, 0).

The camera 21 acquires data of (Yaw, Pitch, Roll) for each imaging optical system as imaging direction data, to determine a positional relationship of each imaging optical system and transmits the imaging direction data to the image processing board 23 with the image data being captured. Accordingly, the image processing board 23 can determine a positional relationship between the captured images (fisheye images) captured by the respective cameras 21 and convert the captured images into the spherical image. In the example of FIG. 8B, the case where the number of imaging optical systems is two is described as an example, but the number of imaging optical systems is not limited to two. The image processing board 23 can convert the captured images (fisheye image) into a spherical image, using the imaging direction data obtained for each imaging optical system. Further, when determining the imaging direction data, the reference direction may be set to one direction of the camera 21, or to a direction expressed relative to the imaging direction of one imaging optical system.

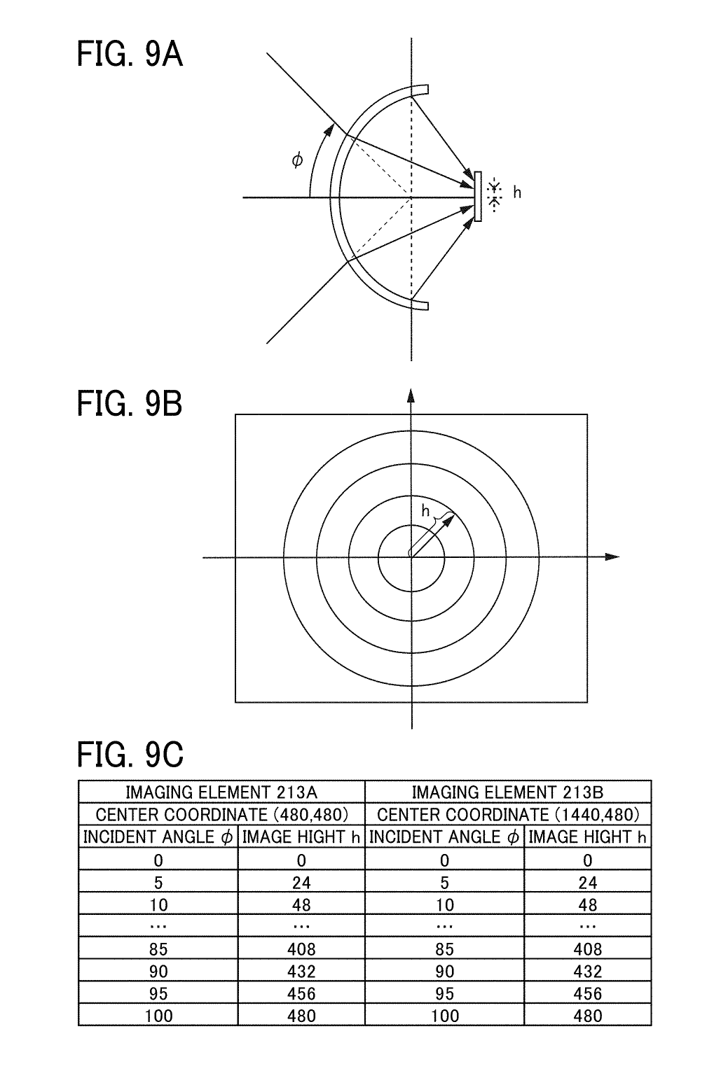

Next, conversion from a fisheye image to a spherical image will be described. FIGS. 9A and 9B are diagrams for explaining a projection relation in a camera having a fish-eye lens. In the present embodiment, the imaging element with one fisheye lens captures an image covering a hemispheric area seen from the image capturing point, that is, directions of substantially 180 degrees. As illustrated in FIG. 9A, the camera with the fisheye lens generates an image having an image height h, which corresponds to an incident angle φ with respect to the optical central axis. The relationship between the image height h and the incident angle φ is determined by a projection function based on a predetermined projection model. The projection function differs depending on the characteristics of the fisheye lens. Specifically, in the fish-eye lens of the projection model called the equidistant projection method, f is expressed as a focal length by the following equation (1). FIG. 9C illustrates an example of the relationship between the incident angle φ and the image height h.

h=f×φ (1)

Other projection models include the central projection method (h=f·tan φ), the stereographic projection method (h=2 f·tan (φ/2)), the isostatic projection method (h=2 f·sin(φ/2)), and the orthogonal projection method (h=f·sin φ). In either method, the image height h of a formed image is determined based on the incident angle φ with respect to the optical central axis and the focal length f. Further, in the present embodiment, it is assumed that a so-called circumferential fisheye lens having an image circle diameter that is smaller than an image diagonal is adopted. Here, the image diagonal (the diagonal line in FIG. 9B) defines the imaging range. As illustrated in FIG. 9B, a partial image that is obtained with such fisheye lens is a planar image (fisheye image), which includes the entire image circle covering substantially a hemispherical part of the imaging range.

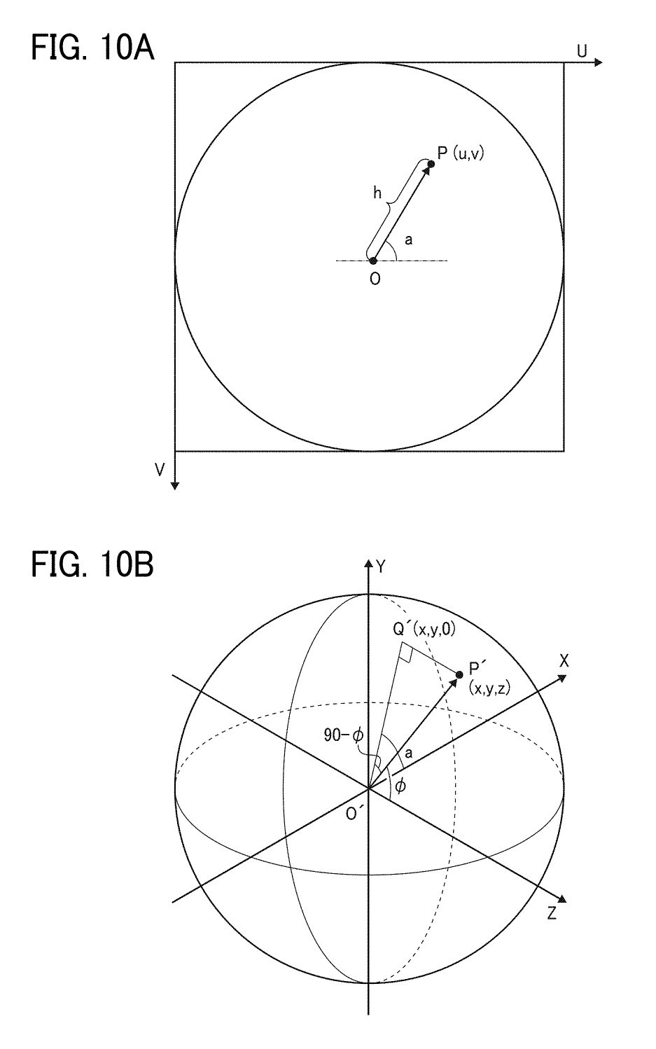

The description of converting from the fisheye image to the spherical image continues. FIGS. 10A and 10B are diagrams for explaining an example of texture mapping of a fisheye image captured by the camera 21 as described above, on a three-dimensional sphere. FIG. 10A illustrates a fisheye image, and FIG. 10B illustrates a unit sphere on which texture mapping is performed with the fisheye image. The fisheye image in FIG. 10A corresponds to the fisheye image in FIG. 9B, and has a point P at the coordinates (u, v). In the fisheye image, an angle “a” is formed by a line passing through the center O and parallel to the U axis, and the line OP. An image height “h” is a distance of the point P from the center O. Referring to a projection data table illustrated in FIG. 9C, the incident angle φ with respect to the image height h of the point P is obtained by various methods such as linear correction. By using the angle “a” and the incident angle φ, the point P (u, v) can be transformed to a point P′(x, y, z) on the corresponding three-dimensional sphere, as illustrated in FIG. 10B.

In FIG. 10B, assuming that the point P′ is projected on the XY plane as the point Q′ (x, y, 0) and the center of the sphere is O′, the angle “a” in FIG. 10A is an angle formed by the X axis and the straight line O′Q′. Further, the incident angle φ is an angle formed by the straight line O′P′ and the Z axis. Since the Z axis is perpendicular to the XY plane, the angle Q′O′P′ between the straight line O′P′ and the XY plane is 90−<φ. From the above, the coordinates (x, y, z) of the point P can be obtained by the following equations (2-1) to (2-3).

x=sin ϕ×cos a (2-1)

y=sin ϕ×sin a (2-2)

z=cos ϕ (2-3)

The coordinates of the point P′ calculated by the equations (2-1) to (2-3) are further rotated using the imaging direction data, to correspond to a direction that the camera 21 was facing during image capturing. Accordingly, the directions defined in FIGS. 8A and 8B are expressed as equations (3-1) to (3-3). The Pitch axis, Yaw axis, and Roll axis defined in FIGS. 8A and 8B correspond to the X axis, the Y axis, and the Z axis of FIG. 10B, respectively.

$$\begin{matrix}( \begin{matrix}xp \\ yp \\ zp\end{matrix} ) = ( \begin{matrix}1 & 0 & 0 \\ 0 & cos ( pitch ) & - sin ( pitch ) \\ 0 & sin ( pitch ) & cos ( pitch )\end{matrix} ) ( \begin{matrix}x \\ y \\ z\end{matrix} ) & ( 3 \text{-} 1 ) \\ ( \begin{matrix}xy \\ yy \\ zy\end{matrix} ) = ( \begin{matrix}cos ( yaw ) & 0 & sin ( yaw ) \\ 0 & 1 & 0 \\ - sin ( yaw ) & 0 & cos ( yaw )\end{matrix} ) ( \begin{matrix}x \\ y \\ z\end{matrix} ) & ( 3 \text{-} 2 ) \\ ( \begin{matrix}xr \\ yr \\ zr\end{matrix} ) = ( \begin{matrix}cos ( roll ) & - sin ( roll ) & 0 \\ sin ( roll ) & cos ( roll ) & 0 \\ 0 & 0 & 1\end{matrix} ) ( \begin{matrix}x \\ y \\ z\end{matrix} ) & ( 3 \text{-} 3 )\end{matrix}$$

From the equations (3-1) to (3-3), the following equation (4) is obtained. By using the equation (4), the fisheye image is applied with perspective projection transformation according to the imaging direction.

$$( \begin{matrix}{x}^{′} \\ {y}^{′} \\ {z}^{′}\end{matrix} ) = ( \begin{matrix}cos ( roll ) & - sin ( roll ) & 0 \\ sin ( roll ) & cos ( roll ) & 0 \\ 0 & 0 & 1\end{matrix} ) ( \begin{matrix}1 & 0 & 0 \\ 0 & cos ( pitch ) & - sin ( pitch ) \\ 0 & sin ( pitch ) & cos ( pitch )\end{matrix} ) ( \begin{matrix}cos ( yaw ) & 0 & sin ( yaw ) \\ 0 & 1 & 0 \\ - sin ( yaw ) & 0 & cos ( yaw )\end{matrix} ) ( \begin{matrix}x \\ y \\ z\end{matrix} ) \qquad ( 4 )$$

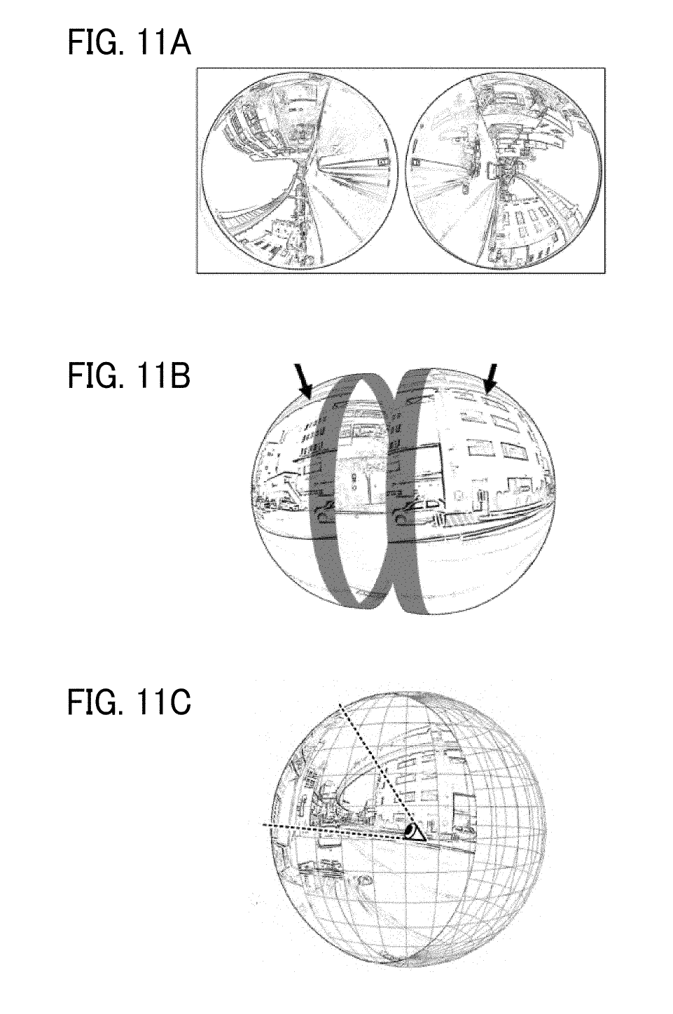

FIGS. 11A to 11C are diagrams illustrating an example of applying perspective projection transformation to the fisheye image. FIGS. 11A to 11C describe an example in which perspective projection transformation is performed, in any arbitrary direction, on images captured by the camera with two fisheye lenses. FIG. 11A illustrates the captured fisheye images. Each fisheye image illustrated in FIG. 11A is converted to a hemispherical image as illustrated in FIG. 11B, through obtaining coordinates on a three-dimensional spherical surface as illustrated in FIGS. 10A and 10B. In FIG. 11B, two hemispherical images, each of which is converted from corresponding one of the fisheye images of FIG. 11A, are combined. In FIG. 11B, a region indicated by a dark color indicates a region where the two hemispherical images overlap with each other.

The hemispherical images of FIG. 11B are merged at appropriate positions, to generate a spherical image as illustrated in FIG. 11C. Furthermore, as illustrated in FIG. 11C, a perspective projection camera is placed virtually at the center of a sphere on which the spherical image is mapped. Here, the perspective projection camera corresponds to a point of view of a user. When displayed to the user, a part of the spherical image (circumferential surface) is cut out in any desired direction with any desired angle of view, according to the point of view of the user. The point of view of the user may be changed, for example, using a pointer (such as a mouse or a user's finger). Accordingly, the user is able to view any part of the spherical image, while changing the user's point of view.

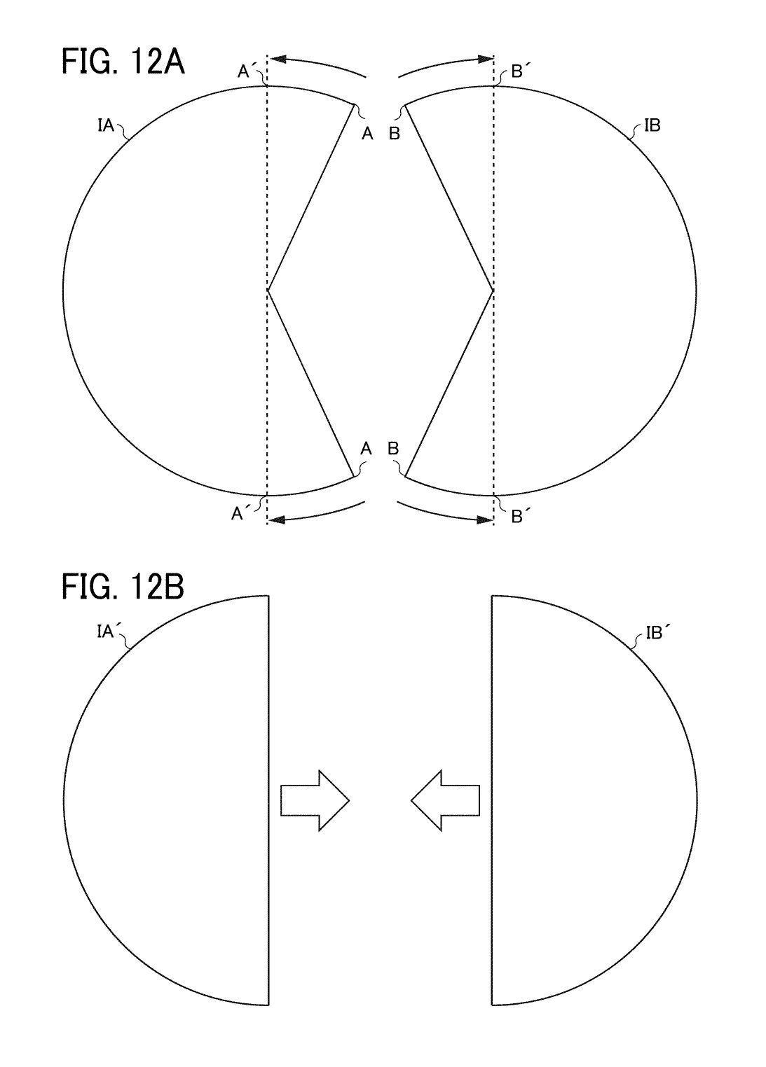

FIGS. 12A and 12B illustrate how the hemispherical images, converted from the fisheye images captured using two fisheye lenses, are combined into a spherical image. As illustrated in FIG. 12A, the hemispherical images IA and IB are generated by texture mapping the images captured respectively by the cameras 21A and 21B onto the unit sphere. The hemispherical images IA and IB each have an angle of view wider than 180°. Therefore, even if the images IA and IB are combined as they are, a spherical image of 360° can not be obtained. The image processing board 23 of the imaging system 20 converts the images IA and IB each having an angle of view wider than 180°, into the images IA′ and IB′ each having the angle of view of 180°. That is, the image processing board 23 converts so that the end portions A and B in the images IA and IB are positioned at the end portions A′ and B′ of FIG. 12A, respectively. Subsequently, as illustrated in FIG. 12B, the image processing board 23 combines the images IA′ and IB′, each obtained by converting the angle of view to 180 degrees as illustrated in FIG. 12A, to generate a spherical image. The imaging system 20 may convert the images IA and IB so that the sum of the angles of view of the images IA ‘and IB’ becomes 360°. For example, if the angles of view of the images IA and IB are each 190°, and the imaging system 20 converts one of the images IA and IB to have an angle of view of 170°, the other one of the images IA and IB is kept to have the angle of view of 190°.

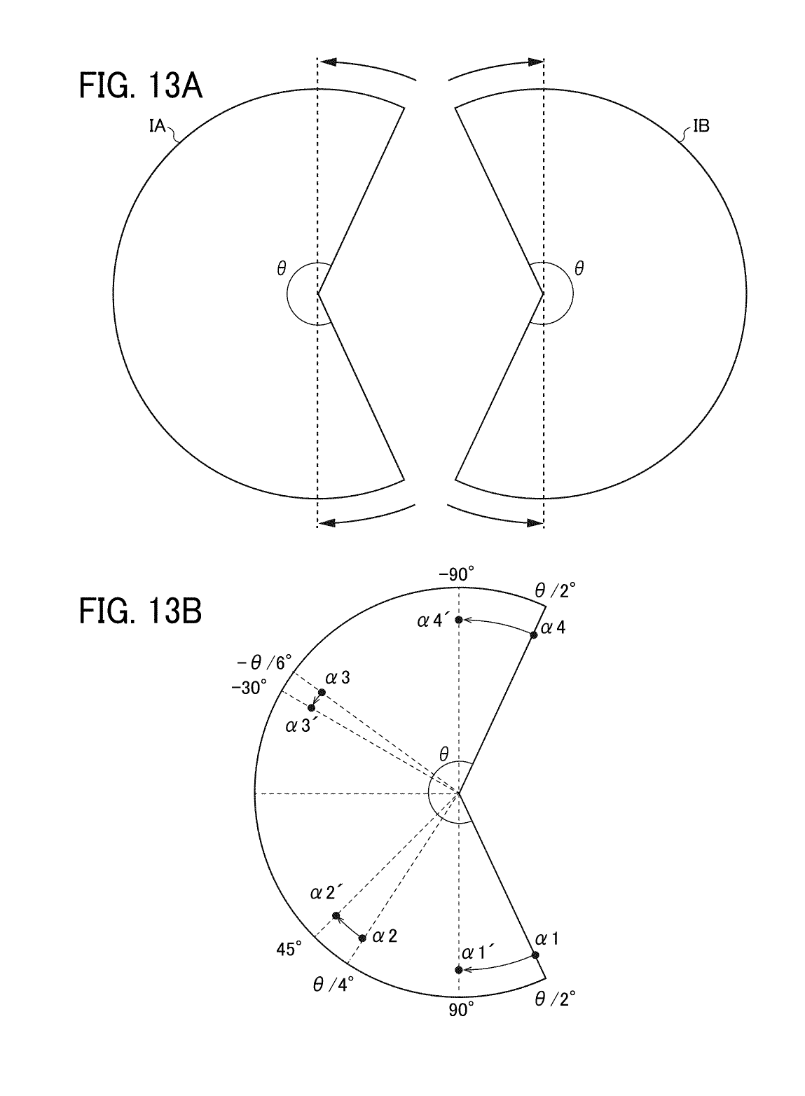

FIGS. 13A and 13B are diagrams for explaining a method of converting images. FIG. 13A illustrates hemispherical images IA and IB, each obtained by performing texture mapping with wide-angle fisheye images captured by the cameras 21A and 21B onto a unit sphere. As illustrated in FIG. 13A, the angle of view of each of the images IA and IB is θ. In order to obtain a spherical image by linearly expanding and compressing the images IA and IB to the images IA′ and IB′ each having the angle of view of 180°, the equation (5) is applied in alternative to the equation (1).

h=f×φ×180°/θ (5)

FIG. 13B illustrates how the image is transformed when the image IA is linearly expanded and compressed into the image IA′. The pixels α1, α2, α3, and α4 of the image IA before conversion move to the positions of the pixels α1′, α2′, α3′, and α4′ in the converted image IA′, respectively. Assuming that the center position of the angle of view is 0°, the pixels at the positions of θ/2°, θ/4°, −θ/6°, and −θ/2° in the image IA, are moved to the positions of 90°, 45°, −30°, and −90° in the image IA′, respectively.

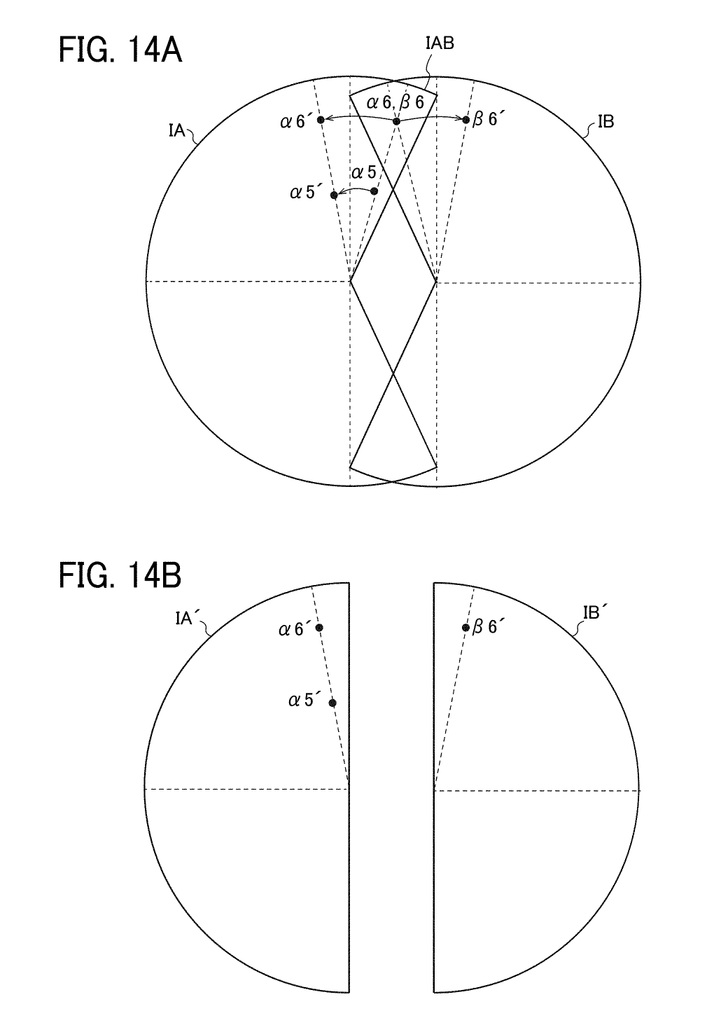

FIGS. 14A and 14B are diagrams for explaining an example of converting an image captured by the imaging system 20, to an image of 1800 by expansion and compression. FIG. 14A illustrates an image before conversion. The pixel α5 in the image IA moves to the position of the pixel α5′ in the converted image IA′. The pixels α6 and β6 in the image IAB, which is the overlapping area of the images IA and IB, move to the positions of the pixels α6′ and 136′ in the converted images IA′ and IB′, respectively. As the converted images IA′ and IB′ are joined together, the same captured object is displayed on each of the pixels α6′ and β6′. That is, the object that has been captured in the image IAB, which is the overlapping area, is displayed in two places after the images are combined.

As described above, using the above-described equations, a table for converting from the fisheye images to a three-dimensional spherical image can be created. In the present embodiment, in order to perform such conversion on the image processing board 23, projection transformation information such as imaging direction data and projection transformation data is added to the image data as supplementary data, and transmitted from the camera 21 to the image processing board 23.

<<Processing>>

Next, processing performed by the imaging system 20 will be described. First, a process of transmitting image data from the camera 21 to the image processing board 23 will be described.

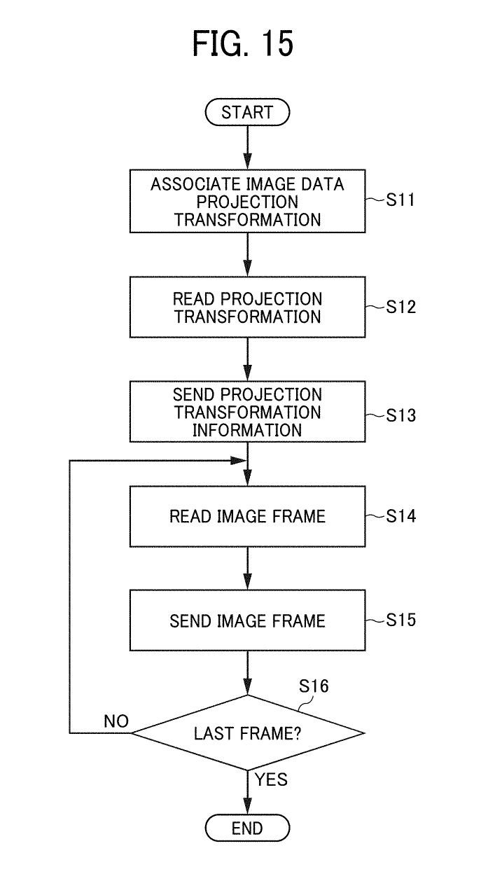

FIG. 15 is a flowchart illustrating operation of obtaining image data and projection transformation information for transmission, performed by the camera 21, according to an embodiment. The projection transformation information includes imaging direction data indicating the angle (Yaw, Pitch, Roll) of the imaging direction of each camera 21 of the imaging system 20, and projection transformation data (table) associating the image height (h) of the image and the incident angle (q) of the light with respect to the imaging system 20.

As the cameras 21A and 21B of the imaging system 20 start capturing images, the image capturing unit 2101 stores the image data of each fisheye image that has been captured, the imaging direction data indicating the imaging direction, and the projection transformation data, in the storage unit 2100. Hereinafter, a case where the captured image is a video will be described. The image data includes frame data of a video encoded by the video encoder 2102. The image manager 2103 associates the stored image data with the projection transformation information (imaging direction data and projection transformation data) (S11). This association is performed, for example, based on a time when each data was stored, and a flag that may be added when capturing the image.

The transmitter 2109 of the camera 21 reads the projection transformation information from the storage unit 2100 (S12), and transmits the projective transformation information of each image data to the image processing board 23 (S13).

Further, the transmitter 2109 reads the frame data of video, processed by the video encoder 216 (S14), and transmits the frame data to the image processing board 23 (S15). The transmitter 2109 determines whether the transmitted frame data is the last frame (S16). When it is the last frame (“YES” at S16), the operation ends. When it is not the last frame (“NO” at S16), the operation returns to S14, and the transmitter 2109 repeats the process of reading frame data and the process of transmitting until the last frame is processed.

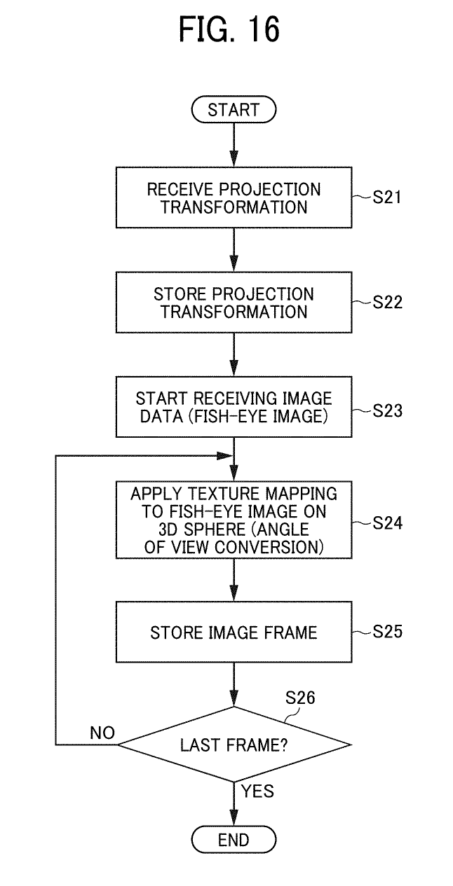

Next, operation to be performed by the image processing board 23 that has received the image data and the projection transformation information will be described. FIG. 16 is a flowchart illustrating operation of generating a spherical image based on the image data and the projection transformation information received from the camera 21, according to an embodiment.

The transmitter and receiver 2309 of the image processing board 23 receives projection transformation information (imaging direction data and projection transformation data), which has been transmitted by the camera 21 (see S13) for each image data (S21). The projection transformation information manager 2301 of the image processing board 23 stores the projection transformation information for each image data that has been received in the storage unit 2300 (S22).

The transmitter and receiver 2309 of the image processing board 23 starts receiving the image data of the fisheye image, transmitted by the camera 21 (see S13) (S23). The storage unit 2300, as an image buffer, stores the received image data.

The conversion unit 2302 of the image processing board 23 reads out a set of image data stored in the storage unit 2300. The set of image data is frame data of a video captured by the cameras 21A and 21B, each of which is associated with the same time information to indicate that the images are taken at the same time. As described above, in alternative to the time information, the flag may be used to indicate the images to be included in the same set. The conversion unit 2302 of the image processing board 23 reads the projection transformation information, associated with the set of these image data from the storage unit 2300.

Each image (image frame) in the set of image data has an angle of view of 180° or more. The conversion unit 2302 converts each image of the set of image data to have an angle of view of 180°, and performs texture mapping with the set of image data that is converted using the projection transformation information to a unit sphere, to generate a spherical image (S24). For the process of converting an image having an angle of view wider than 180° to an image having an angle of view of 180°, any one of the above-described methods may be performed. In this case, the conversion unit 2302 obtains the angle “a” and the image height “h” for each pixel in the fisheye image, obtains φ for each pixel using the projection transformation data in the projection transformation information for each image data using the equation (5), and performs the equations (2-1) to (2-3) to calculate the coordinate (x, y, z) of each pixel.

The conversion unit 2302 stores the converted frame data of a spherical image in the storage unit 2300 (S25). The conversion unit 2302 determines whether the converted image data is the last frame in the video (S26), and the operation ends when it is the last frame (“YES”). When it is determined at S26 that the frame is not the last frame (“NO”), the conversion unit 2302 repeats S24 to S25 of applying texture mapping and storing frame data of a spherical image for the remaining frames.

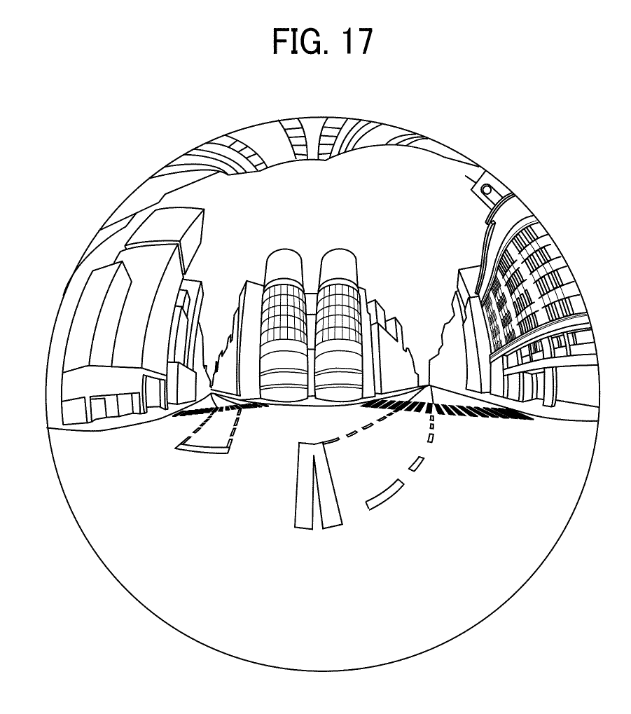

As the operation of FIG. 16 ends, video data, which is frame data of a spherical image, is stored in the storage unit 2300. In response to an input of a request by the user, the displaying unit 2303 reads out the video data stored in the storage unit 2300, causes an external display to display a predetermined area of the spherical image based on each frame data of the video data. FIG. 17 illustrates an example predetermined area of the spherical image, displayed on the display. The video data is obtained by combining two fisheye images each having an angle of view wider than 180°. As described with reference to FIGS. 14A and 14B, any object captured at the same coordinate in the overlapping area of imaging ranges of the two cameras 21A and 21B is displayed at a plurality of times (two times, in this case). For example, referring to FIG. 11B, any object in the overlapping area of imaging ranges of the two cameras 21A and 21B (that is, the overlapping area of two hemispherical images), will be present in each of the two hemispherical images. While the object in the overlapping area is the same object, an imaging condition such as a shooting direction may differ, as these two hemispherical images are taken with different cameras. As described above, according to the present embodiment, a spherical image is generated without discarding the images of the overlapping area. Accordingly, the images taken with different cameras, which may differ in shooting direction, are still kept, thus providing more information on the object in the overlapping area.

### Modified Example A

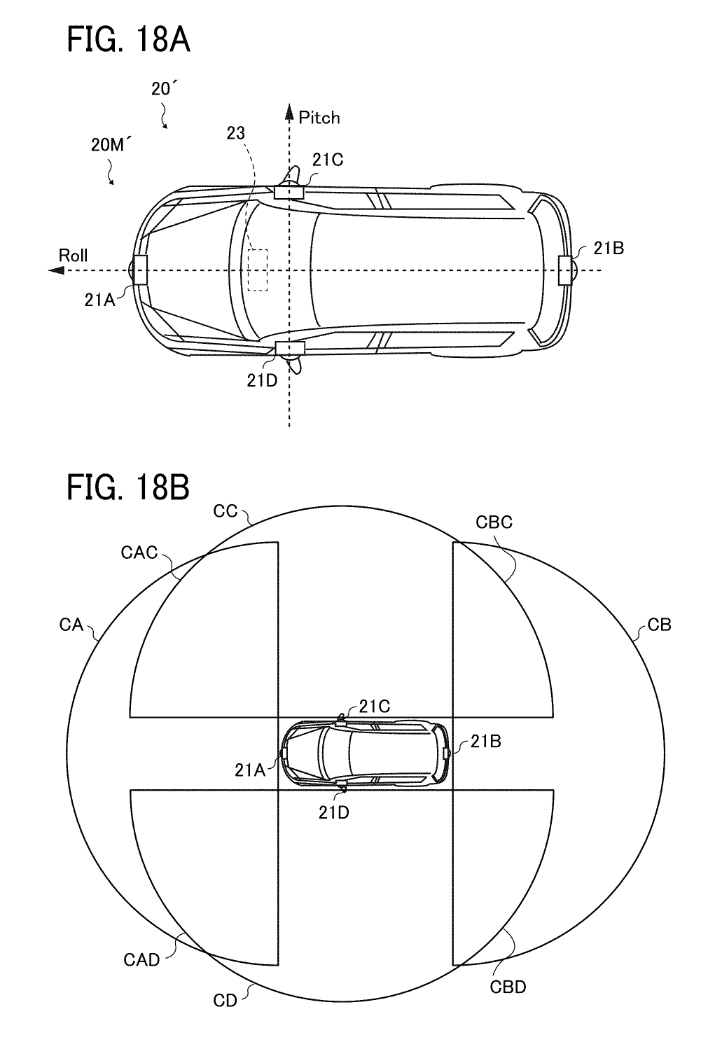

Next, a modified example of the imaging system 20 is described, while only focusing on some differences from the above-described embodiment. FIG. 18 is a schematic diagram illustrating an overall configuration of an imaging system 20′ according to the modified example. FIG. 18A illustrates an example of a mobile object on which the imaging system 20′ is mounted. As illustrated in FIG. 18A, the imaging system 20′ includes cameras 21A, 21B, 21C, and 21D, and an image processing board 23 mounted on a passenger car as the mobile body 20M′. Any arbitrary one of the cameras 21A, 21B, 21C, and 21D is referred to as the camera 21. The hardware configuration of the cameras 21A, 21B, 21C, and 21D is the same as that of the camera 21 in the above-described embodiment. The camera 21 is connected to the image processing board 23 via a wired or wireless communication path.

In FIGS. 18A and 18B, the camera 21A is attached to a front side of the mobile body 20M′, the camera 21B is attached to a rear side of the mobile body 20M′, the camera 21C is attached to a right side mirror of the mobile body 20M′, and the camera 21D is attached to a left side mirror of the mobile body 20M′. The cameras 21A and 21B are disposed so as to face in opposite directions so that their respective optical central axes coincide with each other. The cameras 21C and 21D are disposed so as to face in opposite directions so that their respective optical central axes coincide with each other. The optical central axes of the cameras 21A and 21B and the optical central axes of the cameras 21C and 21D intersect each other. With this configuration, when the images captured by the cameras 21A, 21B, 21C, and 21D are combined, a spherical image with no vertical deviation can be obtained.

In this modified example A, the imaging direction data in the imaging system 20′ is determined, based on assumption that the optical central axis direction in the cameras 21A and 21B is set to the Roll axis, the optical central axis direction in the cameras 21C and 21D is set to the Pitch axis, and the direction perpendicular to the Roll axis and the Pitch axis is set to the Yaw axis.

FIG. 18B is a diagram illustrating an example imaging range of the imaging system 20′. In the imaging system 20′, the angles of view of the cameras 21A, 21B, 21C, and 21D are each 180°. An imaging range CA of the camera 21A and an imaging range CC of the camera 21C overlap each other in a range CAC. An imaging range CC of the camera 21C and an imaging range CB of the camera 21B overlap each other in a range CBC. An imaging range CB of the camera 21B and an imaging range CD of the camera 21D overlap each other in a range CBD. An imaging range CD of the camera 21D and an imaging range CA of the camera 21A overlap each other in a range CAD. According to FIG. 18B, the imaging system 20′ is able to capture all surroundings of the automobile, as the mobile body 20M′, using the four cameras 21′.

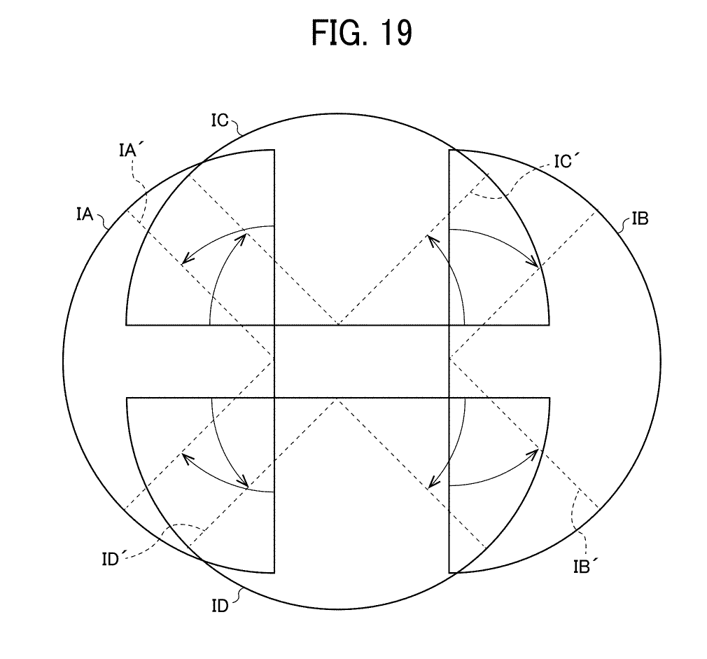

FIG. 19 is a diagram for explaining a method of expanding and compressing an image. FIG. 19 illustrates hemispherical images IA, IB, IC, and ID each having an angle of view of 180°, respectively captured by the cameras 21A, 21B, 21C, and 21D. In the modified example A, as illustrated in FIG. 19, the images IA, IB, IC, and ID each having an angle of view of 180°, are respectively converted through linear expansion and compression, to images IA′, IB′, IC′, and ID′ each having an angle of view of 90°. In order to convert the angle of view θ from 180° to 90°, the image processing board 23 uses equation (6) instead of equation (1).

h=f×φ×90°/θ (6)

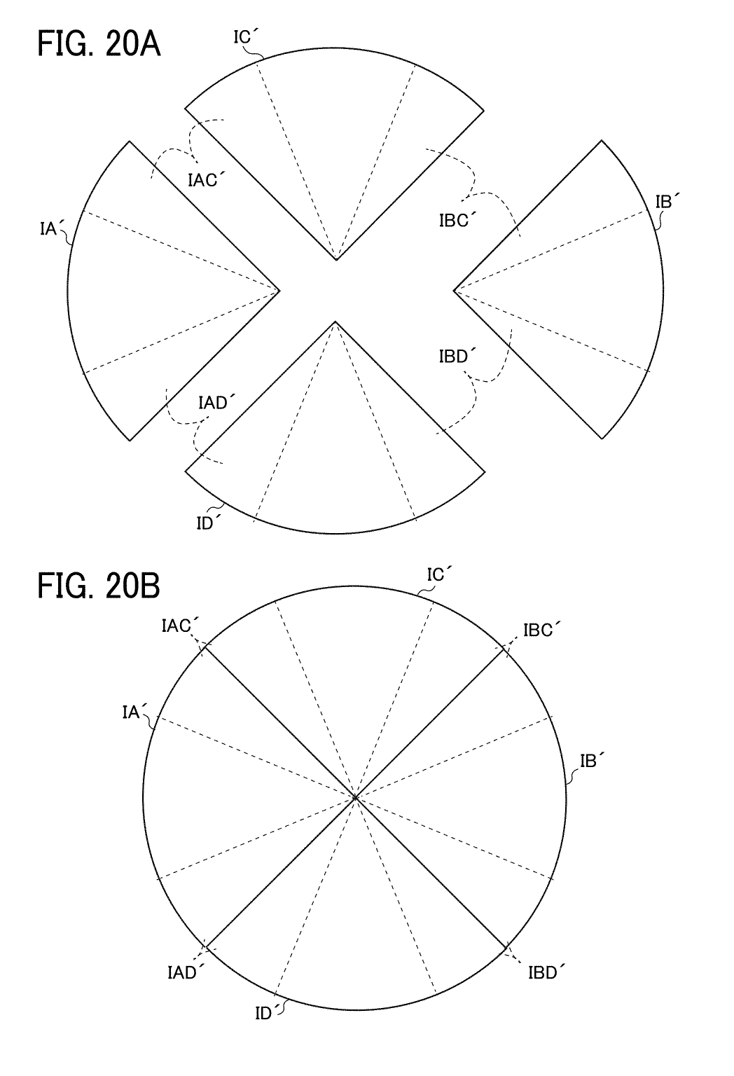

FIGS. 20A and 20B are conceptual diagrams illustrating generating a spherical image, according to the modified example A. FIG. 20A illustrates the images IA′, IB′, IC′, and ID′ each having an angle of view of 90°, which are respectively converted from the images IA, IB, IC, and ID each having an angle of view of 180°. By converting the angle of view, the images IAC′, IBC′, IBD′, and IAD′ of the overlapping areas that have been captured by two of the cameras 21A, 21B, 21C, and 21D are also compressed. FIG. 20A illustrates a spherical image obtained by combining the converted images IA′, IB′, IC′, and ID′. The spherical image is obtained by combining four images each having an angle of view of 90°. As illustrated in FIG. 20B, any object captured in the overlapping area of imaging ranges of two of the four cameras 21A, 21B, 21C, and 21D is displayed at a plurality of times at the same coordinate. As described above, according to the present embodiment, a spherical image is generated without discarding the image of the overlapping area.

The above-described modified example A is similar to the above-described embodiment, except that four images are captured and that the angle of view of 180° is converted to 90° using the equation (6).

### Modified Example B

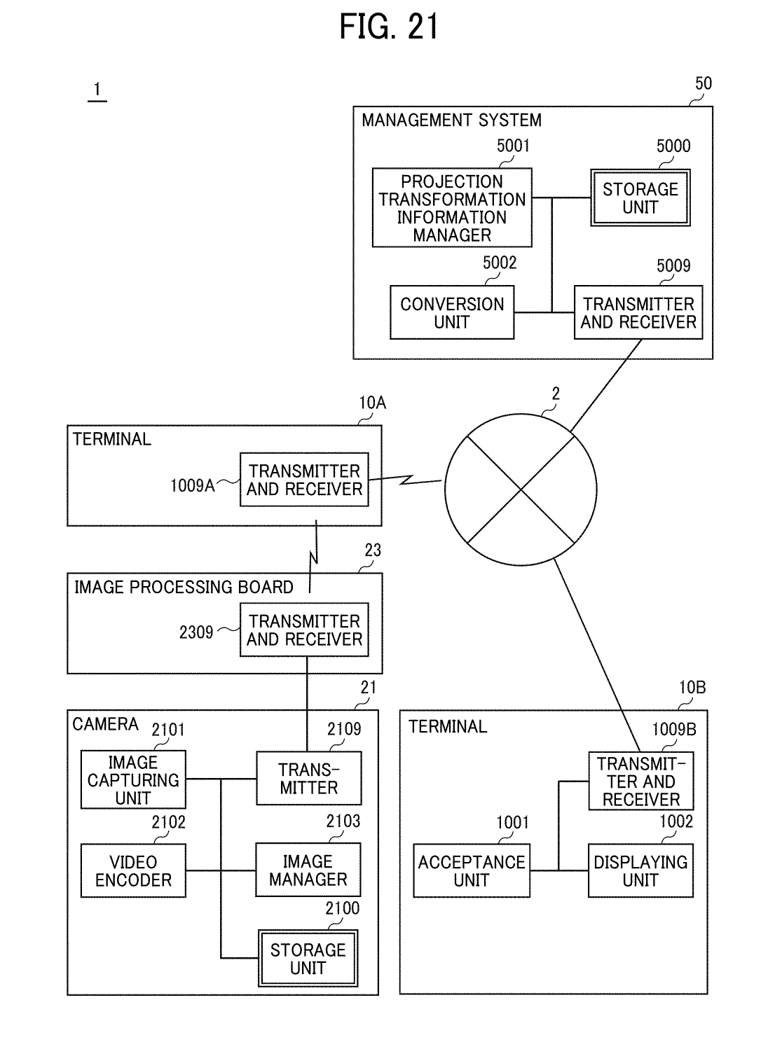

Next, another modified example of the imaging system 20 is described, while only focusing on some differences from the above-described embodiment. FIG. 21 is a schematic block diagram illustrating a functional configuration of the terminals 10A and 10B, the camera 21, the image processing board 23, and the management system 50, in the communication system 1, according to the modified example B of the embodiment.

The functional configuration of the camera 21 is similar to that of the camera 21 in the above-described embodiment. The functional configuration of the transmitter and receiver 2309 of the image processing board 23 is the same as that of the image processing board 23 in the above-described embodiment.

The terminal 10A includes a transmitter and receiver 1009A. The transmitter and receiver 1009A, which is implemented by instructions of the CPU 101 and the network I/F 107, controls communication with other devices.

The management system 50 includes a projection transformation information manager 5001, a conversion unit 5002, and a transmitter and receiver 5009. The management system 50 further includes a storage unit 5000, implemented by the ROM 102, the RAM 103, or the SSD 104. The projection transformation information manager 5001, which is implemented by instructions of the CPU 101, manages projection transformation information of an image that is captured by the camera 21. The conversion unit 5002, which is implemented by instructions of the CPU 101, converts an angle of view of each image in a set of images, to generate a set of images each applied with projection transformation. The conversion unit 5002 then performs texture mapping with the set of images applied with projection transformation, onto a unit sphere, using projection transformation information to generate a sphere image. The transmitter and receiver 5009, which is implemented by instructions of the CPU 101 and the network I/F 107, controls communication with other devices.

The terminal 10B includes a transmitter and receiver 1009B, an acceptance unit 1001, and a displaying unit 1002. The transmitter and receiver 1009B, which is implemented by instructions of the CPU 101 and the network I/F 107, controls communication with other devices. The acceptance unit 1001 accepts instructions of the CPU 101, and an operation input by the user through a touch panel via the user I/F 108. The displaying unit 1002, which is implemented by instructions of the CPU 101 and a displaying function of the user I/F 108, displays images on a display.

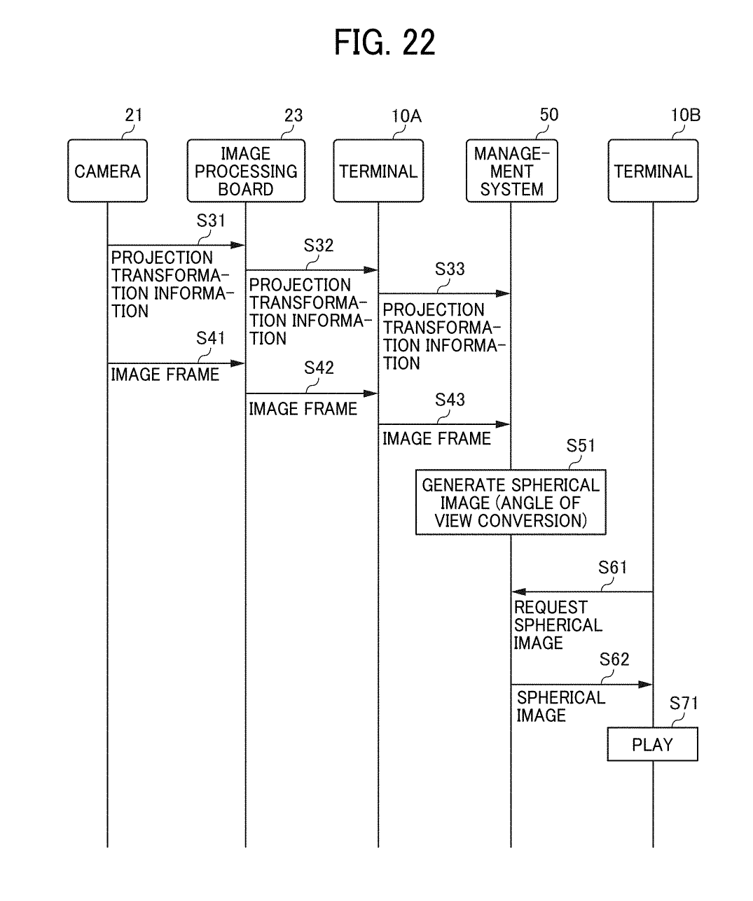

FIG. 22 is a sequence diagram illustrating operation of generating and reproducing a spherical image, performed by the communication system 1, according to the modified example B of the embodiment. As image capturing starts, the camera 21 transmits projection transformation information for each image data being captured, to the image processing board 23, in a substantially similar manner as described above referring to S11 to S13 of FIG. 15 (S31).

In response to reception of the projection transformation information from the camera 21, the transmitter and receiver 2309 of the image processing board 23 transmits the received projection transformation information to the terminal 10A (S32).

In response to reception of the projection transformation information from the image processing board 23, the transmitter and receiver 1009A of the terminal 10A transmits the received projection transformation information to the management system 50 (S33). The transmitter and receiver 5009 of the management system 50 receives the projection transformation information transmitted from the terminal 10A.

The cameras 21A and 21B each transmit frame data of the captured video to the image processing board 23, in a substantially similar manner as described above referring to S14 to S16 of FIG. 15 in the above-described embodiment (S41).

In response to reception of frame data of the video transmitted from the camera 21, the transmitter and receiver 2309 of the image processing board 23 transmits the received frame data of the video to the terminal 10A (S42).

In response to reception of the frame data of the video transmitted from the image processing board 23, the transmitter and receiver 1009A of the terminal 10A transmits the frame data of the video to the management system 50 (S43). The transmitter and receiver 5009 of the management system 50 receives the frame data of the video transmitted by the terminal 10A.

Using the received projection transformation information and the frame data of the video, the management system 50 generates video data of a spherical image in a substantially similar manner as described above referring to S21 to S26 of FIG. 16 (S51). That is, in the modified example B, the management system 50 performs processing of generating a spherical image, which is performed by the image processing board 23 in the above-described embodiment. The generated video data is stored in the storage unit 5000.

As the user of the terminal 10B inputs an operation for requesting displaying of the spherical image, the acceptance unit 1001 receives a request for the spherical image. The transmitter and receiver 1009B of the terminal 10B transmits a request for the spherical image to the management system 50 (S61).

The transmitter and receiver 5009 of the management system 50 receives the request for the spherical image transmitted from the terminal 10B. In response to this request, the transmitter and receiver 5009 of the management system 50 reads the video data of the spherical image from the storage unit 5000, and transmits the read video data to the terminal 10B.

The transmitter and receiver 1009B of the terminal 10B receives the video data of the spherical image, transmitted from the management system 50. The displaying unit 1002 displays (reproduces), on the display, the spherical image based on the received video data (S71).

According to one or more embodiments, the imaging system 20 includes a plurality of cameras 21A and 21B each of which captures an image with a preset angle of view, such as an angle of view wider than 180 degrees. Here, the sum of the angles of view of the cameras 21A and 21B is greater than 360 degrees. Accordingly, the imaging area of one camera 21 overlaps with that of the other camera 21. The image processing board 23 processes the images of all surroundings, taken by the cameras 21. Specifically, the conversion unit 2302 of the image processing board 23 converts at least one image, from among the plurality of images captured by the plurality of cameras 21, into an image having a predetermined angle of view smaller than the original angle of view. The conversion unit 2302 then combines a plurality of images including the at least one converted image, to generate a spherical image. With this conversion processing, when combining a plurality of images to generate an image of all surroundings, loss of information on overlapping areas of the plurality of images can be prevented.

Especially when the images are being captured for the purpose of monitoring, it is important that no information would be lost.

The conversion unit 2302 of the image processing board 23 converts the angle of view so that the sum of the angles of view of the plurality of images acquired by the plurality of cameras 21A and 21B becomes 360°. As a result, when the image processing board 23 combines a plurality of images to generate a spherical image, no overlapping areas of the plurality of images are generated such that a loss in image can be prevented.

The imaging system 20 includes two cameras 21A and 21B. The conversion unit 2302 of the image processing board 23 converts the image having an angle of view wider than 180°, which is acquired by each of the two cameras 21A and 21B, into an image having an angle of view of 180°. Accordingly, even when the installation space for the camera is small like in the case of a small-size construction machine, as long as the imaging system 20 with the two cameras 21A and 21B can be installed, surroundings of a target, such as the construction machine, can be captured.

The cameras 21A and the cameras 21B are arranged so as to face in opposite directions while keeping a predetermined distance therebetween, such that different directions can be captured at substantially the same time. If the cameras 21A and 21B are disposed at the same location, there may be areas not captured due to a blind spot of the vehicle or the like. By placing the cameras at a predetermined distance, an image of surroundings can be sufficiently captured.

In the modified example A of the embodiment, the imaging system 20 includes four cameras 21A, 21B, 21C, and 21D. The conversion unit 2302 of the image processing board 23 converts an image having an angle of view wider than 90°, acquired by each of the four cameras 21A, 21B, 21C, and 21D, into an image having an angle of view of 90°. As a result, even if there is an area that cannot be captured due to the blind spot with the two cameras 21A and 21B, by installing the four cameras 21A, 21B, 21C, and 21D, an image of all surroundings can be captured.

As described above for the case of two cameras, two of the camera 21A, the camera 21B, the camera 21C, and the camera 21D are arranged so as to face in opposite directions while keeping a predetermined distance from each other, so that different directions can be captured at substantially the same time.

Any one of the programs for controlling the terminal 10, the imaging system 20, and the management system 50 may be stored in a computer-readable recording medium in a file format installable or executable by the general-purpose computer for distribution. Examples of such recording medium include, but not limited to, compact disc-recordable (CD-R), digital versatile disc (DVD), and blue-ray disc. In addition, a memory storing any one of the above-described control programs, such as a recording medium including a CD-ROM or a HDD, may be provided in the form of a program product to a user within a certain country or outside that country.

The terminals 10, the imaging system 20, and the management system 50 in any one of the above-described embodiments may be configured by a single computer or a plurality of computers to which divided portions (functions) are arbitrarily allocated.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

For example, processing to combine the images may be performed in various ways, such as by integrating one image with another image, mapping one image on another image entirely or partly, laying one image over another image entirely or partly. That is, as long as the user can perceive a plurality of images being displayed on a display as one image, processing to combine the images is not limited to this disclosure.

For example, the method of combining images may be performed in a substantially similar manner as described in U.S. Patent Application Publication No. 2014/0071227A1, the entire disclosure of which is hereby incorporated by reference herein.

1. An image processing apparatus for processing a plurality of images captured by an image capturing device, the image capturing device including a plurality of imaging elements each configured to capture an imaging area with a preset angle of view, imaging areas of at least two of the plurality of imaging elements overlapping with each other, the image processing apparatus comprising:
circuitry configured to:
obtain the plurality of images captured by the image capturing device;
convert at least one image of the plurality of images, to an image having an angle of view that is smaller than the preset angle of view; and
combine the plurality of images including the at least one image that is converted, into a combined image.

2. The image processing apparatus of claim 1, wherein the circuitry converts the at least one image to have the angle of view, such that a sum of angles of view of the plurality of images to be combined becomes 360 degrees, the combined image being a spherical image.

3. The image processing apparatus of claim 2, wherein, when the plurality of imaging elements is two imaging elements each configured to capture an imaging area with an angle of view larger than 180 degrees,
the circuitry converts each of the plurality of images to have an angle of view of 180 degrees.

4. The image processing apparatus of claim 2, wherein, when the plurality of imaging elements is four imaging elements each configured to capture an imaging area with an angle of view larger than 180 degrees,
the circuitry converts each of the plurality of images to have an angle of view of 90 degrees.

5. The image processing apparatus of claim 1, wherein, in combining the plurality of images, the circuitry keeps information of an object in an overlapping area of the imaging areas of the at least two of the plurality of imaging elements overlapping with each other.

6. The image processing apparatus of claim 1, wherein the circuitry converts the image to have the angle of view smaller than the preset angle of view, by linear expansion and compression.

7. The image processing apparatus of claim 1, further comprising:
an interface circuit configured to output the combined image for display to a user.

8. An imaging system comprising:
the information processing apparatus of claim 1; and
the image capturing device communicably connected with the information processing apparatus, and configured to transmit the plurality of images to the information processing apparatus.

9. The imaging system of claim 8,
wherein at least two of the plurality of imaging elements are arranged so as to face in opposite directions, while keeping a predetermined distance from each other.

10. A communication system comprising:
the image processing apparatus of claim 1; and
a communication terminal communicably connected with the image processing apparatus,
wherein, in response to a request from the communication terminal, the image processing apparatus transmits the combined image to the communication terminal for display.

11. An image processing method for processing a plurality of images captured by an image capturing device, the image capturing device including a plurality of imaging elements each configured to capture an imaging area at a preset angle of view, imaging areas of at least two of the plurality of imaging elements overlapping with each other, the image processing method comprising:
obtaining the plurality of images captured by the image capturing device;
converting at least one image of the plurality of images, to an image having an angle of view that is smaller than the preset angle of view; and
combining the plurality of images including the at least one image that is converted, into a combined image.

12. A non-transitory recording medium which, when executed by one or more processors, cause the processors to perform an image processing method for processing a plurality of images captured by an image capturing device, the image capturing device including a plurality of imaging elements each configured to capture an imaging area at a preset angle of view, imaging areas of at least two of the plurality of imaging elements overlapping with each other, the image processing method comprising:
obtaining the plurality of images captured by the image capturing device;
converting at least one image of the plurality of images, to an image having an angle of view that is smaller than the preset angle of view; and
combining the plurality of images including the at least one image that is converted, into a combined image.
